(19) United States
(12) Patent Application Publication
(10) Pub. No.: US 2018/0205239 A1
(43) Pub. Date: Jul. 19, 2018

(54) POWER SUPPLY MODULE WITH LITHIUM ION CAPACITOR

(71) Applicant: TAIYO YUDEN CO., LTD., Tokyo (JP)

(72) Inventors: Toshifumi MATSUTAKA, Takasaki-shi (JP); Mitsuo NAKAJIMA, Takasaki-shi (JP); Hajime HASEGAWA, Takasaki-shi (JP)

(21) Appl. No.: 15/868,951

(22) Filed: Jan. 11, 2018

(30) Foreign Application Priority Data
Jan. 17, 2017 (JP) 2017-006063

(51) Int. Cl. H02J 7/00

(52) U.S. Cl. CPC H02J 7/0014; H02J 7/345; H02J 7/0026

(57) ABSTRACT

A power supply module to be installed on a drive unit in a removable manner includes: a lithium ion capacitor unit that contains at least one lithium ion capacitor cell; a power supply line for supplying power to the drive unit; a first switch unit provided on the power supply line; a protective circuit constituted so that it turns off the first switch based on the voltage of the lithium ion capacitor; and a second switch unit that has at least one switching element, provided between the lithium ion capacitor unit and the protective circuit. The second switch unit is constituted so that it turns on based on a control signal input from the drive unit while the power supply module is installed on the drive unit, and turns off while the control signal is not input. The power supply can suppress leak current from a lithium ion capacitor.

### BACKGROUND

### Field of the Invention

The present invention relates to a power supply module constituted in a manner freely installable on and removable from a load, and specifically to a power supply module with a lithium ion capacitor.

### Description of the Related Art

Power supply units using lithium ion capacitors have traditionally been known. For example, Japanese Patent Laid-open No. 2016-5357 discloses a power supply unit for vehicles that uses a lithium ion capacitors.

Generally, in a power supply unit that uses a lithium ion capacitor or other power storage device, a protective circuit is provided to prevent the power storage device from over-charging or over-discharging. This type of protective circuit is constituted so that, when an over-charge or over-discharge of the power storage device is detected, the switch provided on the power supply line turns off to cut off the discharge from the power storage device or charge to the power storage device. For example, Japanese Patent Laid-open No. 2011-134578 discloses an example of a protective circuit for preventing a lithium ion battery from over-charging or over-discharging.

Background Art Literatures
[Patent Literature 1] Japanese Patent Laid-open No. 2016-005357
[Patent Literature 2] Japanese Patent Laid-open No. 2011-134578

### SUMMARY

A power supply unit in which a protective circuit is provided presents a problem that, as leak current flows into the protective circuit from a lithium ion capacitor, the voltage of the lithium ion capacitor drops.

A power supply module may be used as a backup power supply for a server or other drive unit. Such power supply module used as a backup power supply is to be stored for a long period of time while not connected to a drive unit. With a conventional power supply module, the voltage of the lithium ion capacitor drops while the power supply module is in storage, because leak current still flows from the lithium ion capacitor to the protective circuit while the power supply module is not connected to a drive unit, and the voltage often drops to below 2.2 V, which defines the lower limit of an appropriate operating voltage range, in around six months to a year. Accordingly, conventional power supply modules must be charged periodically at intervals of around six months to a year while in storage.

Not only power supply modules used for servers, but all types of power supply modules that can be installed on a drive unit in a removable manner are assumed to be stored for a long period of time in an unused state. Accordingly, a power supply module that can be installed on a drive unit in a removable manner requires suppression of leak current from the lithium ion capacitor.

An object of the present invention is to suppress leak current from a lithium ion capacitor in a power supply module that can be installed on a drive unit in a removable manner. Other objects of the present invention are made clear through the entire text of the Specification.

Any discussion of problems and solutions involved in the related art has been included in this disclosure solely for the purposes of providing a context for the present invention, and should not be taken as an admission that any or all of the discussion were known at the time the invention was made.

The power supply module pertaining to an embodiment of the present invention is a power supply module to be installed on a drive unit in a removable manner. This power supply module comprises: a lithium ion capacitor unit that contains at least one lithium ion capacitor cell; a power supply line for supplying power to the drive unit; a first switch unit provided on the power supply line; a protective circuit that prevents over-charge and/or over-discharge of the at least one lithium ion capacitor cell; and a second switch unit that has at least one switching element, provided between the lithium ion capacitor unit and the protective circuit. The lithium ion capacitor unit may have multiple lithium ion capacitors that are connected in series.

The second switch unit is constituted so that it turns on based on a control signal input from the drive unit while the power supply module is installed on the drive unit, and turns off while the control signal is not input. In an embodiment of the present invention, the second switch unit is constituted so that it has multiple second switching elements provided between the respective multiple lithium ion capacitor cells and the protective circuit, and so that each of the multiple second switching elements turns on based on the control signal and turns off while the control signal is not input.

According to the aforementioned embodiment, the protective circuit is connected to the lithium ion capacitor only while the power supply module is installed on the drive unit. This means that, while the power supply module is in storage instead of being installed on the drive unit, leak current does not flow from the lithium ion capacitor to the protective circuit.

The power supply module pertaining to an embodiment of the present invention has an equalization circuit provided in parallel with the lithium ion capacitor unit. In this case, the second switch unit is provided between the equalization circuit and the lithium ion capacitor unit. The equalization circuit may have multiple resistors provided in parallel with the multiple lithium ion capacitors, respectively, as well as multiple third switches provided in series with the multiple resistors, respectively. In this case, each of the multiple third switches turns on and off according to the voltage of the corresponding lithium ion capacitor cell among the multiple lithium ion capacitor cells.

According to the aforementioned embodiment, generation of leak current from the lithium ion capacitor to the equalization circuit can also be prevented while the power supply module is in storage instead of being installed on the drive unit.

According to each of the aforementioned embodiments of the present invention, leak current from the lithium ion capacitor can be suppressed in the power supply module that can be installed on a drive unit in a removable manner. In particular, generation of leak current from the lithium ion capacitor unit to the protective circuit can be prevented while the power supply module is in storage instead of being installed on the drive unit. As a result, the power supply module can be stored for a long period of time without charging it.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawings of preferred embodiments which are intended to illustrate and not to limit the invention. The drawings are greatly simplified for illustrative purposes and are not necessarily to scale.

FIG. 1 is a block diagram showing key parts of the power supply module pertaining to an embodiment of the present invention.

### DESCRIPTION OF THE SYMBOLS

1 Drive unit
10 Power supply module
11 Lithium ion capacitor unit
11a, 11b, 11c Lithium ion capacitor cell
12 Protective circuit
13 Switch unit
13a, 13b, 13c Switching element
14 Equalization circuit
15 Switch unit
16, 17 Power supply terminal
18 Connection terminal
L1, L2 Power supply line

### DETAILED DESCRIPTION OF EMBODIMENTS

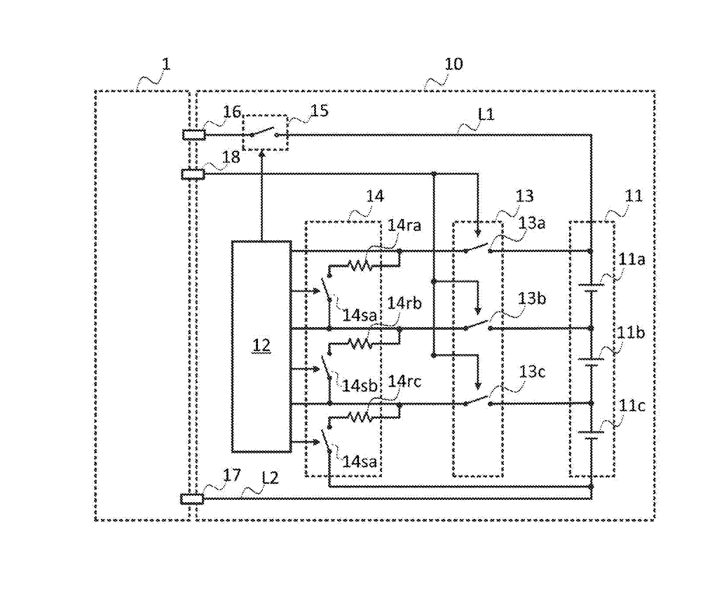

Various embodiments of the present invention are explained below by referring to the drawing as deemed appropriate. FIG. 1 is a block diagram showing key parts of the power supply module pertaining to an embodiment of the present invention. As shown in the FIGURE, the power supply module 10 pertaining to an embodiment of the present invention is connected to a drive unit 1 via power supply terminals 16, 17 and a connection terminal 18.

The drive unit 1 is a unit that can operate on the power supplied from the power supply module 10. The drive unit 1 is a server that operates on the power supplied from the power supply module 10, for example. Under the present invention, the drive unit 1 used with the power supply module 10 need not be a server. The drive unit 1 may be any unit on which the power supply module 10 is installed in a removable manner, and which can operate on the power supplied from the power supply module 10 while the power supply module 10 is installed.

The power supply module 10 is used as a backup power supply for the drive unit 1, for example. The power supply module 10 is constituted so that it can be installed on the drive unit 1 in a removable manner. While the power supply module 10 is not in use, the power supply module 10 is removed from the drive unit 1.

To supply power to the drive unit 1 from the power supply module 10, the power supply module 10 is installed on the drive unit 1. Once the power supply module 10 is installed on the drive unit 1, the power supply module 10 is connected to the drive unit 1 via the power supply terminals 16, 17 and connection terminal 18, as mentioned above.

The power supply module 10 comprises: a lithium ion capacitor unit 11; a protective circuit 12 for preventing over-charge and over-discharge of the lithium ion capacitor unit 11; a switch unit 13 provided between the lithium ion capacitor unit 11 and the protective circuit 12; and a switch unit 15 provided on a power supply line L1. These respective components of the power supply module 10 are described in detail below.

The lithium ion capacitor unit 11 has at least one lithium ion capacitor cell (lithium ion capacitor cell is hereinafter simply referred to as “cell”). In the embodiment shown in the FIGURE, the lithium ion capacitor unit 11 has three lithium ion capacitor cells 11a, 11b, 11c (hereinafter simply referred to as “cell 11a,” etc.”) that are connected in series. The lithium ion capacitor unit 11 may have only one cell or two cells, or it may have four or more cells. The cells 11a, 11b, 11c are charged and discharged in such a way that the voltage of each cell always remains within a prescribed operating voltage range. This operating voltage range is normally 2.2 to 3.8 V.

For the cells 11a, 11b, 11c, any known lithium ion capacitor cells may be used. Known lithium ion capacitor cells are disclosed in Japanese Patent Laid-open No. 2012-256694 and Japanese Patent Laid-open No. 2013-105839, for example.

The lithium ion capacitor unit 11 is connected to the positive terminal 16 via the power supply line L1, and also to the negative terminal 17 via a power line L2. The power in the lithium ion capacitor unit 11 is supplied to the drive unit 1 via these power lines L1, L2.

Provided between the lithium ion capacitor unit 11 and the terminal 16 on this power supply line L1 is the switch unit 15 which is on/off-controlled by the protective circuit 12. The switch unit 15 has one or multiple switching elements being on/off-controlled by the protective circuit 12. For such switching element, any analog switch, MOSFET, PHOTOMOS relay, or other known switching element may be used. The switch unit 15 may be provided on the power supply line L2.

The protective circuit 12 is a microcontroller comprising a CPU core, ROM, RAM, and various input/output ports integrated into one semiconductor chip, for example. The protective circuit 12 detects the voltage of the lithium ion capacitor unit 11, and based on this detected voltage, it turns off the switching element provided in the switch unit 15 in order to prevent over-charge and over-discharge of the lithium ion capacitor unit 11. This over-charge/over-discharge prevention control by the protective circuit 12 may be implemented based on the cell voltage of each of the cells 11a, 11b, 11c, or based on the total voltage of the lithium ion capacitor unit 11, as explained below.

In an embodiment of the present invention, the protective circuit 12 detects the cell voltage of each of the cells 11a, 11b, 11c of the lithium ion capacitor unit 11, and controls the switch unit 15 based on the detected cell voltage. For example, the protective circuit 12 detects the cell voltage of each of the cells 11a, 11b, 11c, and if any one of the detected cell voltages exceeds a prescribed upper-limit value, it turns off the switching element provided in the switch unit 15 to inhibit charge to the lithium ion capacitor unit 11. This control prevents over-charge of the lithium ion capacitor unit 11. In another example of operation, the protective circuit 12 is constituted so that, if the cell voltage of any of the cells 11a, 11b, 11c drops below a prescribed lower-limit value, it turns off the switching element provided in the switch unit 15 to inhibit discharge from the lithium ion capacitor unit 11. This control prevents over-discharge of the lithium ion capacitor unit 11.

In another embodiment of the present invention, the protective circuit 12 detects the total voltage of the lithium ion capacitor unit 11, which is applied between both ends of the lithium ion capacitor unit 11 (between the positive electrode of the cell 11a and the negative electrode of the cell 11c), and controls the switch unit 15 based on the detected total voltage. To be specific, the protective circuit 12 detects the total voltage of the lithium ion capacitor unit 11, and if the detected total voltage exceeds a prescribed upper-limit value, it turns off the switching element provided in the switch unit 15 to inhibit charge to the lithium ion capacitor unit 11. If the total voltage of the lithium ion capacitor unit 11 drops below a prescribed lower-limit value, on the other hand, the protective circuit 12 turns off the switching element provided in the switch unit 15 to inhibit discharge from the lithium ion capacitor unit 11.

The protective circuit 12 may have a function other than preventing over-charge and over-discharge. For example, the protective circuit 12 may be constituted to detect shorting, capacity drop, resistance increase, or any other abnormality of the cells 11a, 11b, 11c.

In an embodiment of the present invention, the switch unit 15 has multiple switching elements, or multiple MOSFETs, for example. Of these multiple MOSFETs, one MOSFET may be constituted so that, when turned off, it cuts off only the current flowing in the direction of charging the lithium ion capacitor unit 11. Of these multiple MOSFETs, another MOSFET may be constituted so that, when turned off, it cuts off only the current flowing in the direction of discharging the lithium ion capacitor unit 11. Having these MOSFETs, the protective circuit 12 can selectively inhibit charge or discharge of the lithium ion capacitor unit 11 according to the on/off control of the switch unit 15. This means that the protective circuit 12 can prevent over-charge and over-discharge of the lithium ion capacitor unit 11 via on/off control of the switch unit 15.

In an embodiment of the present invention, the switch unit 13 has one or multiple switching elements. For such switching element, any analog switch, MOSFET, PHOTOMOS relay, or other known switching element may be used. In the embodiment shown in the FIGURE, the switch unit 13 has three switching elements 13a, 13b, 13c. The number of switching elements in the switch unit 13 may be the same as the number of cells in the lithium ion capacitor unit 11. In the embodiment shown in the FIGURE, the switch unit 13 has three switching elements 13a, 13b, 13c, because the lithium ion capacitor unit 11 has three cells.

As mentioned above, the switch unit 13 is provided between the lithium ion capacitor unit 11 and the protective unit 12. To be specific, the switching elements 13a, 13b, 13c are provided between the positive electrodes of the corresponding cells 11a, 11b, 11c, and the protective circuit 12, respectively.

In an embodiment of the present invention, the switch unit 13 is constituted so that it turns on while a wakeup signal is input from the connection terminal 18, and turns off while a wakeup signal is not input from the connection terminal 18.

In an embodiment of the present invention, a wakeup signal generated by the drive unit 1 is input to the switch unit 13, via the connection terminal 18, while the power supply module 10 is installed on the drive unit 1. In an embodiment of the present invention, this wakeup signal is input to the switch unit 13 from the connection terminal while the power supply module 10 is installed on the drive unit 1 and each cell voltage remains within the operating voltage range of 2.2 to 3.8 V; however, once the power supply module 10 is removed from the drive unit 1 or each cell voltage deviates from the operating voltage range by dropping to below 2.2 V or rising above 3.8 V, the wakeup signal is no longer input to the switch unit 13.

The wakeup signal from the connection terminal 18 is input to each of the switching elements 13a, 13b, 13c, and all of the switching elements 13a, 13b, 13c are turned on by this wakeup signal. Once the switching elements 13a, 13b, 13c turn on, the lithium ion capacitor unit 11 becomes electrically conductive with the protective circuit 12. As a result, the protective circuit 12 can detect the voltage of the lithium ion capacitor unit 11 while the power supply module 10 is installed on the drive unit 1 and a wakeup signal is input to the switch unit 13, and implement a control to prevent over-charge or over-discharge of the lithium ion capacitor unit 11 based on the detected value.

While the power supply module 10 is removed from the drive unit 1, on the other hand, the protective circuit 12 is cut off from the lithium ion capacitor unit 11 and therefore generation of leak current from the lithium ion capacitor unit 11 to the protective circuit 12 can be prevented.

If the lithium ion capacitor unit 11 has multiple cells, the power supply module 10 may further have an equalization circuit 14. The equalization circuit 14 is used to equalize the cell voltages of the respective cells of the lithium ion capacitor unit 11. If the lithium ion capacitor unit 11 has multiple cells, the varying self-discharge characteristics and varying cell capacities of the respective cells result in varying cell voltages, when no equalization circuit 14 is provided. Varying cell voltages mean that the cell voltages of some cells are likely to deviate from the operating voltage range. The equalization circuit 14 is a circuit that suppresses these varying cell voltages. If the lithium ion capacitor unit 11 has only one cell, no equalization circuit 14 is required.

In an embodiment of the present invention, the equalization circuit 14 is provided in parallel with the lithium ion capacitor unit 11. In the embodiment shown in the FIGURE, the equalization circuit 14 may comprise: a balance resistor 14ra provided in parallel with the cell 11a; a switching element 14sa provided in series with this balance resistor 14ra; a balance resistor 14rb provided in parallel with the cell 11b; a switching element 14sb provided in series with this balance resistor 14rb; a balance resistor 14rc provided in parallel with the cell 11c; and a switching element 14sc provided in series with this balance resistor 14rc. The number of balance resistors in the equalization circuit 14 may be the same as the number of cells in the lithium ion capacitor unit 11.

The switching elements 14sa, 14sb, 14sc are constituted to be on/off-controlled by the protective circuit 12. For example, the protective circuit 12 determines the time during which the switching element 14sa should remain on based on the detected value of cell voltage of the cell 11a, and turns on the switching element 14sa for the time thus determined. While the switching element 14sa remains on, discharge current flows to the balance resistor 14ra from the cell 11a, and the cell voltage of the cell 11a drops as a result. The times during which the switching elements 14sa, 14sb, 14sc should remain on are set based on the cell voltages of the corresponding cells 11a, 11b, 11c. By setting a longer on time for the switching element corresponding to each cell of a higher cell voltage than the on time of the switching element corresponding to other cells, the cell voltages of the respective cells are equalized.

If the power supply module 10 has an equalization circuit 14, the switch unit 13 is provided between this equalization circuit 14 and the lithium ion capacitor unit 11. Still, the layout of the lithium ion capacitor unit 11 and protective circuit 12 need not be changed. This means that, if the power supply module 10 has an equalization circuit 14, the switch unit 13 is provided between the equalization circuit 14 and the lithium ion capacitor unit 11, which is also between the protective circuit 12 and the lithium ion capacitor unit 11.

While the power supply module 10 is installed on the drive unit 1 and a wakeup signal is input to the switch unit 13, the equalization circuit 14 is connected to the lithium ion capacitor unit 11, and therefore the equalization circuit 14 operates in a manner equalizing the cell voltages of the cells 11a, 11b, 11c. While the power supply module 10 is removed from the drive unit 1, on the other hand, the equalization circuit 14 is cut off from the lithium ion capacitor unit 11, and therefore generation of leak current from the lithium ion capacitor unit 11 to the equalization circuit 14 can be prevented.

As described above, the power supply module 10 is constituted so that it can be installed on the drive unit 1 in a removable manner, and when it is not installed on the drive unit 1, generation of leak current from the lithium ion capacitor unit 11 to the protective circuit 12 can be prevented. Accordingly, the power supply module 10 can be stored for a long period of time without charging it.

The dimensions, materials and layout of each of the components explained in this Specification are not limited to those explained explicitly in the embodiments, and each such component may be altered to have any desired dimensions, materials and layout included in the scope of the present invention. In addition, a component not explicitly explained in this Specification may be added to the embodiments explained herein, or any part of a component explained in each embodiment may be omitted.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. The terms “constituted by” and “having” refer independently to “typically or broadly comprising”, “comprising”, “consisting essentially of”, or “consisting of” in some embodiments. In this disclosure, any defined meanings do not necessarily exclude ordinary and customary meanings in some embodiments.

The present application claims priority to Japanese Patent Application No. 2017-006063, filed Jan. 17, 2017, the disclosure of which is incorporated herein by reference in its entirety including any and all particular combinations of the features disclosed therein.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A power supply module to be installed on a drive unit in a removable manner, comprising:
a lithium ion capacitor unit that contains at least one lithium ion capacitor cell;
a power supply line for supplying power to the drive unit;
a first switch unit provided on the power supply line;
a protective circuit that prevents over-charge and/or over-discharge of the at least one lithium ion capacitor cell; and
a second switch unit that has at least one switching element, provided between the lithium ion capacitor unit and the protective circuit;
wherein the second switch unit is constituted in a manner turning on when receiving a control signal input from the drive unit while the power supply module is installed on the drive unit, and turning off while receiving no control signal input from the drive unit.

2. The power supply module according to claim 1, wherein the lithium ion capacitor unit has multiple lithium ion capacitor cells that are connected in series.

3. The power supply module according to claim 2, wherein:
the second switch unit has multiple second switching elements provided between the respective multiple lithium ion capacitor cells and the protective circuit; and
each of the multiple second switching elements is constituted in a manner turning when receiving the control signal, and turning off while receiving no control signal.

4. The power supply module according to claim 2, wherein:
an equalization circuit is provided in parallel with the lithium ion capacitor unit; and
the second switch unit is provided between the equalization circuit and the lithium ion capacitor unit.

5. The power supply module according to claim 3, wherein:
an equalization circuit is provided in parallel with the lithium ion capacitor unit; and
the second switch unit is provided between the equalization circuit and the lithium ion capacitor unit.

6. The power supply module according to claim 4, wherein:
the equalization circuit has multiple resistors provided in parallel with the multiple lithium ion capacitors, respectively, as well as multiple third switches provided in series with the multiple resistors, respectively; and
each of the multiple third switches turns on and off according to a voltage of a corresponding lithium ion capacitor cell among the multiple lithium ion capacitor cells.

7. The power supply module according to claim 5, wherein:
the equalization circuit has multiple resistors provided in parallel with the multiple lithium ion capacitors, respectively, as well as multiple third switches provided in series with the multiple resistors, respectively; and
each of the multiple third switches turns on and off according to a voltage of a corresponding lithium ion capacitor cell among the multiple lithium ion capacitor cells.
